(19) United States
(12) Patent Application Publication
(10) Pub. No.: US 2006/0284024 A1
(43) Pub. Date: Dec. 21, 2006

(54) Audio component mounting assembly

(76) Inventors: Ray Call, Mission Viejo, CA (US); Jon Berges, Mission Viejo, CA (US); Mitchell R. Witten, Carlsbad, CA (US)

Correspondence Address: STETINA BRUNDA GARRED & BRUCKER, 75 ENTERPRISE, SUITE 250, ALISO VIEJO, CA, 92656, US

(21) Appl. No.: 11/157,252

(22) Filed: Jun. 21, 2005

(51) Int. Cl. G12B 9/00

(52) U.S. Cl. 248/27.1

(57) ABSTRACT

An audio component mounting housing may be provided which is engageable to wall framing members. The housing may be disposable within an opening formed in the wallboard. The housing may also have at least one fastener receiving aperture through which a fastener may be inserted and engaged to the wall framing member to engage the housing to a wall. Further, the fastener receiving aperture may extend laterally or diagonally from the housing such that passage of the fastener through the aperture secures the housing to wall framing members laterally or diagonally adjacent a mounting periphery of the housing.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates to an audio component mounting bracket, for mounting audio components (e.g., speakers, MP3 players, XM radios, etc.) into structural surfaces, such as a wall or ceiling. More particularly, the invention relates to an in-wall/in-ceiling mounting bracket suitable for interfacing hand-held audio devices to a remote audio system, and is supportable by engagement to an adjacent wall framing member, e.g. studs.

With the introduction of high quality in-wall/in-ceiling speakers, the sophistication and utility of speaker mounting brackets has also undergone considerable evolution. Speaker mounting brackets may generally be classified as new construction brackets and retrofit brackets. New construction brackets may be mounted to the framing members before wallboard is applied. Apertures may then be cut in the wallboard as it is secured to the framing members, to allow the speaker output to pass through the wallboard when the speaker is mounted securely within the bracket. Various new types of new construction brackets are available, including FLEXBRACKETS marketed by Sonance™.

Retrofit brackets are typically used where a wall is already built, and access to framing members is more difficult. Typically an aperture is cut in the wallboard and the bracket, already mounted to the speaker housing, is inserted within the aperture. The bracket is then tightened to mount the speaker on the wallboard, by compressing the wallboard between the mounting bracket and the speaker front flange. Such retrofit brackets secure the speaker housings firmly in place against the wallboard to assure reliable structural configuration and high quality audio performance. Examples of such high quality retrofit brackets include the ROTOLOCK mounting brackets marketed by Sonance™.

Accordingly, conventional, new construction speaker mounting brackets may be readily secured to framing members, and retrofit speaker mounting brackets may be readily mounted to wallboard. However, mounting difficulties may still arise in relation to retrofit installations, where unanticipated obstacles are found inside the wall, making the use of conventional retrofit brackets difficult or completely unsatisfactory. While such difficulties can be addressed by various on-site adaptations, the end result may be cumbersome and inefficient.

Speaker installers generally prefer use of speaker mounting brackets that are quick and easy to install. Multi-zone in-wall speaker systems may require the installation of a dozen or more speakers in walls or ceilings of a home, office or other facility. It is therefore desirable for installers to utilize a bracket speaker assembly and connecting bracket that is designed to facilitate quick and easy installation, despite the discovery of various obstructions within a wall. Such obstructions may include various types of beams, cross members, electrical equipment and other articles that may interfere with the use of existing brackets or connecting members.

For example, an installer may cut an aperture into a wall and mount a speaker for retrofit installation of a speaker, only to find that a stud or cross member is located adjacent the aperture, making it difficult or impossible to orient a rotatable flange to engage the speaker assembly to the wallboard adjacent the framing member. In such instances the installer may attempt to extend the bracket or connecting members, or some portion thereof, to engage the framing member rather than the wallboard. However, such installation may be difficult or unsatisfactory insofar as surface contacts may be limited, and the connection members may be offset and unstable. Moreover, the time to contrive such an installation may significantly degrade the efficiency of the installation.

Accordingly, there exists a need to provide an improved speaker mounting assembly that can be quickly and securely installed, despite the discovery of mounting obstacles. It is further desirable that the improved speaker mounting assembly not complicate the instruction or installation of the assembly. It is further desirable that a provision of such alternate mounting capabilities be done in a manner that does not impose additional production costs or significantly detract from the performance of the speaker.

These and other features and advantages are disclosed in connection with the preferred embodiment of the invention described and illustrated below.

### BRIEF SUMMARY

An audio component mounting housing is provided to mount an audio component to a structural surface such as a ceiling or wall of a building, as a retrofit. To this end, the audio component mounting housing may be inserted into a hole created in a wallboard and engaged to a wall framing member. The audio component may then be mounted into the audio component mounting housing to finish installing the audio component into the structural surface.

The housing having at least one fastener receiving aperture and may be inserted or disposed within an opening formed in wallboard. The fastener receiving aperture may be aligned to the wall framing member behind the wall board and secured thereto via a fastener. In particular, the fastener is inserted into the fastener receiving aperture and secured to the wall framing member.

The fastener receiving aperture may be variously configured. By way of example and not limitation, the fastener receiving aperture may extend laterally outward or diagonally outward. Additionally, after the fastener has been inserted into the fastener receiving aperture and secured the housing to the wall framing member, a cover may be disposed over the faster receiving aperture and the fastener for aesthetic appeal and to prevent the fastener from loosening out of the fastener receiving aperture.

### BRIEF DESCRIPTION OF THE DRAWINGS

These as well as other features of the present invention will become more apparent upon reference to the drawings wherein:

FIG. 1 is a front perspective view of an audio component mounting housing mounted into a structural surface, a fastener securing the housing to a wall framing member of the structural surface, and a cover attachable over the fastener;

FIG. 2 is a rear perspective view of the audio component mounting housing; and

FIG. 3 is a flow chart of steps for installing the housing to the structural surface.

### DETAILED DESCRIPTION

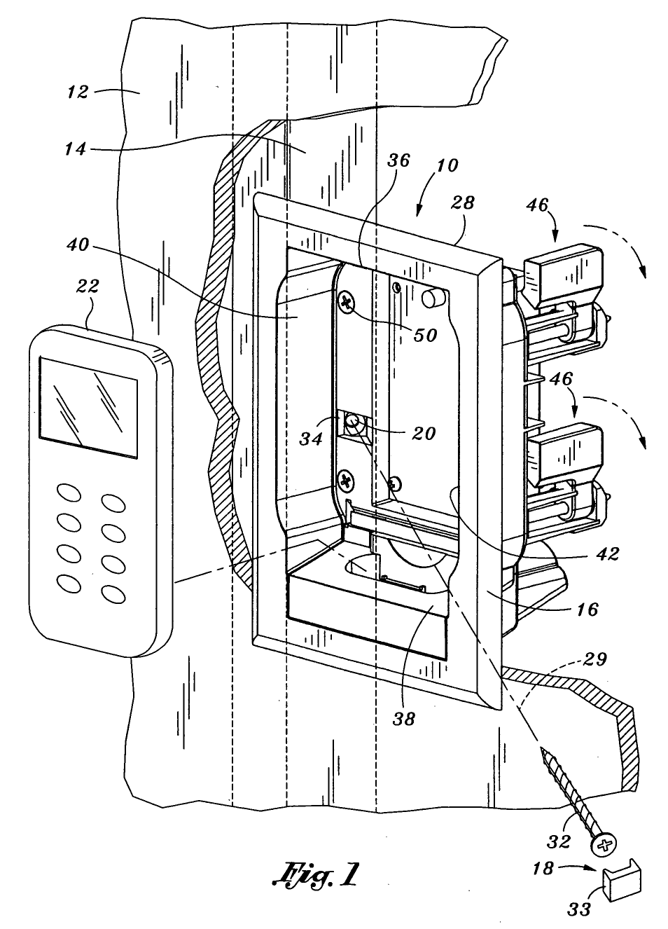

Referring now to FIG. 1, a front perspective view of an audio component mounting housing 10 for an audio component, and more particularly, an audio player is shown wherein the housing 10 is mounted into a wallboard 12. The audio component mounting housing 10 is engageable to the wallboard 12 and wall framing members 14. The wallboard 12 is an exterior surface visible to residents and guests of a home or building. The wallboard 12 is typically one half (½) inch drywall painted on its exterior side so as to be aesthetically pleasing to residents and guests of a home or building. Behind the wallboard 12 may be a plurality of wall framing members 14. Typically, the wall framing members 14 are wooden 2×4's placed vertically along a wall to form the wall. The vertical 2×4's are then horizontally interconnected via short length 2×4's to make the vertical 2×4's rigid. Only the vertical 2×4's are shown in FIG. 1. After the frame of the wall is formed by the vertical and horizontal wall framing members 14, the wallboard 12 is attached to the plurality of wall framing members 14 and an exterior side of the wallboard 12 is painted so as to make the wallboard 12 aesthetically pleasing.

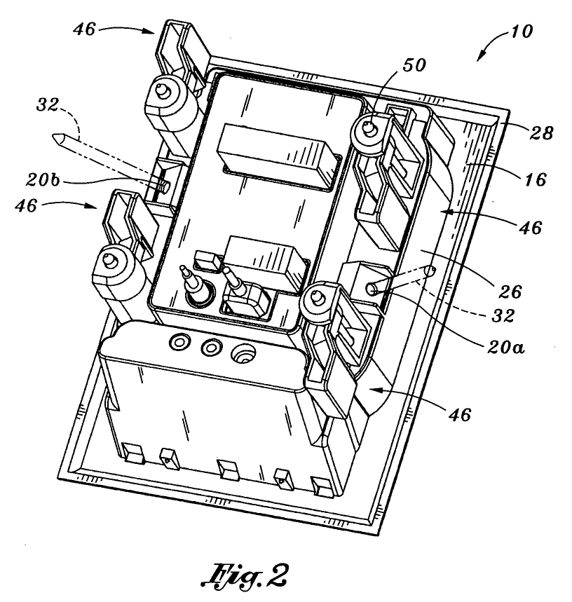

In accordance with the present invention the housing 10 may be engaged to the wall framing members 14 via a fastener 32 such as screw, nail, fastener and/or the like. As shown in FIG. 2, the audio component mounting housing 10 may comprise a fastener receiving aperture 20a, 20b. Also, as shown in FIG. 1, a cover 18 may be inserted over the fastener 32 via a friction fit to provide for an aesthetically appealing outer surface and to prevent the fastener 32 from falling out of the fastener receiving aperture 20. An outer periphery 33 of the cover 18 may be sized and configured to have a friction fit with the inner surface 34 of the fastener receiving aperture 20. The housing 10 may be fabricated from a unitary material such as plastic via blow molding. As shown in FIG. 1, the housing 10 may be sized and configured to receive an audio component 22 such as a speaker or an audio player (i.e., speakers, MP3 players, XM radios, iPod™, etc.). In particular, the housing 10 may have a cavity or recessed area on its exterior side sized and configured to closely follow the outer contour of the desired audio component 22.

An opening may be formed in the wallboard 12 which is sized and configured to receive and support the housing 10. The opening may be sufficiently large to receive a mounting periphery 26 (see FIG. 2) of the housing 10 within the opening but sufficiently small such that a front flange 28 (see FIGS. 1 and 2) extending about the mounting periphery 26 extends beyond the opening formed in the wallboard 12. The opening shown in the drawings is located adjacent the wall framing member 14.

The housing 10 when disposed within the opening may be unexpectedly positioned such that the fastener receiving aperture 20 is adjacent to a wall framing member. For example, as shown in FIG. 1, the housing 10 is positioned such that the fastener receiving aperture 20 is adjacent to wall framing members 14 when the housing 10 is disposed within the opening. In this instance, a fastener may be passed through the fastener receiving aperture 20 and into the wall framing member 14 to secure the housing 10 to the wall framing member 14.

The fastener receiving aperture 20 may define a central axis 29. The central axis 29 of the fastener receiving aperture 20 may be perpendicularly aligned to the adjacent wall framing member. Alternatively, the central axis 29 of the fastener receiving aperture 20 may be skewed with respect to the adjacent wall framing member 14. Advantageously, the installer may install the housing 10 into the wall despite the unexpected position of the wall framing member 14.

The housing 10 may define an upper side 36, a lower side 38, a left side 40 and a right side 42, as shown in FIG. 1. The left and right sides 40, 42 of the housing 10 may have formed or engaged thereto at least one fastener receiving aperture 20. The fastener receiving aperture 20 permits the fastener 32 to be inserted therethrough, and depending on the angular orientation of the fastener receiving aperture 20, the fastener may extend diagonally outward or laterally outward to adjacent wall framing members 14. It is also contemplated within the scope of the present invention that a plurality of fastener receiving apertures 20 be formed in the upper side 36, the lower side 38 as well as the left and right sides 40, 42 of the housing 10 such that fasteners 32 may be attached or engaged to the vertical and/or horizontal wall framing members 14.

Other components of the audio system may also be attached to the audio component mounting housing discussed herein. By way of example and not limitation, if the audio component is a speaker, a speaker baffle may be disposed within the receiving area of the housing 10 and attached to the housing 10.

Additionally, a plurality of dawgs 46 may be attached to the housing 10 to engage the housing 10 to the wallboard 12 and/or wall framing members 14. In particular, the dawgs 46 may be rotatable about an axis perpendicular to the exterior surface of the wallboard 12. The dawgs 46 may have a retracted position and deployed position. The retracted position shown in FIGS. 1 and 2 is defined when the dawgs 46 are rotated inward, and the deployed position of the dawgs 46 is defined when the arms 48 are rotated outward. Once the dawgs 46 are traversed to the deployed position, the dawgs 46 may be drawn toward the front flange 28 of the housing 10 via a screw 50. In this manner, the mounting periphery 26 of the housing 10 may be disposed within the inner periphery of the opening 24. Thereafter, the dawgs 46 may be rotated to the deployed position such that the wallboard is disposed between the arms 48 and the front flange 28 of the housing 10. Thereafter, the dawgs 46 are drawn toward the front flange 28 to engage the wallboard 12. The wallboard 12 is squeezed by the front flange 28 and the dawgs 46 thereby securing the housing 10 to the wallboard 12. Alternatively, the dawgs 46 and the front flange 28 may compress the wall framing member 14 to secure the housing 10 to the wall framing member 14.

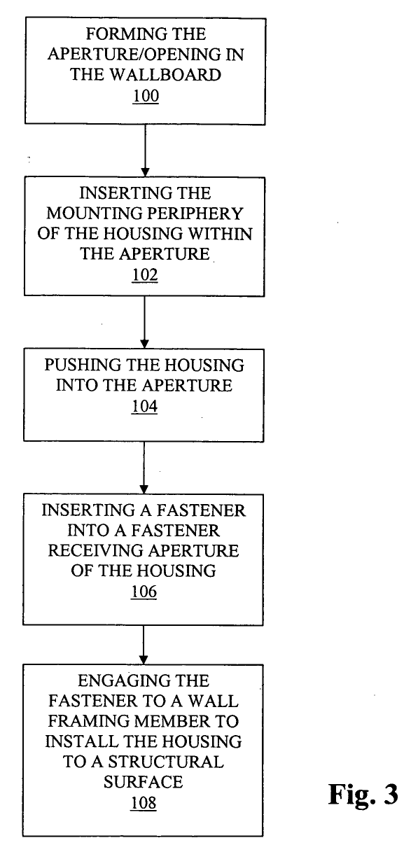

In another aspect of the housing 10, as shown in FIG. 3, a method of installing the housing 10 is disclosed. The method may include the steps of forming (step 100) the aperture/opening in the wallboard 12 so as to be sized and configured to fit the mounting periphery 26 of the housing 10. The method may also include the step of inserting (step 102) the mounting periphery 26 of the housing 10 within the aperture, pushing (step 104) the housing 10 into the aperture until the front flange 28 of the housing 10 is flush with the wallboard 12, inserting (step 106) the fastener 32 into the fastener receiving aperture 20 of the housing 10, and engaging (step 108) the fastener 32 to the wall framing member 14 to install the housing 10 to the structural surface.

Additionally, the method of installing the housing 10 may include the step of disposing the cover 18 over the fastener 32 for providing an aesthetically pleasing exterior appearance of the housing 10 and preventing the fastener 32 from loosening out of the fastener receiving aperture 20. Also, the disposing the cover step may include the step of frictionally engaging the outer periphery 33 of the cover 18 to an inner surface 34 of the fastener receiving aperture 20.

The above description is given by way of example, and not limitation. Given the above disclosure, one skilled in the art could devise various variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An audio component mounting assembly engagable to wallboard and wall framing members comprising:
a housing disposable within an opening formed in the wallboard;
at least one fastener receiving aperture formed in the housing for passing a fastener through the aperture, a central axis of the aperture being aligned to intersect the wall framing member for engaging a fastener to the wall framing member when the fastener is passed through the fastener receiving aperture.

2. The assembly as recited in claim 1 further comprising at least one cover frictionally engageable to an inner surface of the fastener receiving aperture for covering the fastener.

3. The assembly as recited in claim 1 wherein the central axis of the fastener receiving aperture extends diagonally from the housing and is skewed with respect to the wall framing member.

4. The assembly as recited in claim 1 further comprising a speaker baffle connected to the housing.

5. The assembly as recited in claim 1 wherein the housing includes first and second sides, and wherein a first fastener receiving aperture is formed on the housing first side and a second fastener receiving aperture is formed on the housing second side.

6. The assembly as recited in claim 5 further comprising at least one fastener insertable through the fastener receiving aperture for securing the housing to the wall framing member.

7. The assembly as recited in claim 6 wherein the fastener comprises a screw.

8. The assembly as recited in claim 7 wherein the fastener comprises a nail.

9. A method of installing an audio component mounting housing to a structural surface, the structural surface including a wallboard and wall framing member, the method comprising the steps of:
a) forming a hole within the wallboard which is sized and configured to fit a mounting periphery of the housing;
b) inserting the mounting periphery of the housing within the hole;
c) pushing the housing into the hole until a flange of the housing is flush with the wallboard;
d) inserting a fastener into a fastener receiving aperture of the housing wherein a central axis of the fastener receiving aperture intersects the wall framing member; and
e) engaging the fastener to the wall framing member for installing the housing to the structural surface.

10. The method as recited in claim 9 further comprising the step of disposing a cover over the fastener for providing an aesthetically pleasing exterior appearance of the housing and preventing the fastener from loosening out of the fastener receiving aperture.

11. The method as recited in claim 10 wherein the disposing the cover step includes frictionally engaging an outer periphery of the cover to an inner surface of the fastener receiving aperture.
